(19) United States
(12) Patent Application Publication
(10) Pub. No.: US 2022/0164096 A1
(43) Pub. Date: May 26, 2022

(54) SPATIO-TEMPORAL MESSAGING SYSTEM AND METHOD

(71) Applicant: Urbanoid Inc., Montréal (CA)

(72) Inventors: Pascal MAEDER, Montréal (CA); Leonid REINOSO MEDINA, La Habana (CU); Arturo MAEDER, Bromont (CA)

(21) Appl. No.: 17/455,815

(22) Filed: Nov. 19, 2021

Related U.S. Application Data
(60) Provisional application No. 63/198,916, filed on Nov. 21, 2020.

(51) Int. Cl. G06F 3/0484; G06F 40/166; H04L 12/58; G06F 16/9537

(52) U.S. Cl. CPC G06F 3/04847; G06F 40/166; G06F 3/04842; G06F 2203/04805; H04L 51/32; G06F 16/9537; H04L 51/16

(57) ABSTRACT

A spatio-temporal messaging system through which people can connect with one another by posting and replying to messages. The system is based on events which take place in reality in either the past, present or future, and which are documented by users on the messaging platform. Messages are created with associated spatio-temporal coordinates. Posts referring to a single message or a message thread are identified by markers which visibility can be filtered by navigating a map in longitude, latitude and scale. Messages are searchable using graphical representations of space and time including maps and a time-gliding tool. Users can anonymously access and navigate the platform for the purpose of reading markers headers, creating new message or replying to existing messages. The platform randomly attributes a unique username to new users who will automatically retain it for future sessions if they use the same environment.

### CROSS-REFERENCE TO RELATED APPLICATIONS

The present application claims priority to U.S. Provisional Patent Application Ser. No. 63/198,916 filed on Nov. 21, 2020, the entire contents of which are hereby incorporated by reference.

### NOTICE OF COPYRIGHT

A portion of the disclosure of this patent application contains material that is subject to copyright protection. The copyright owner has no objection to the facsimile reproduction by anyone of the material subject to copyright protection as it appears in the United States Patent & Trademark Office's records for this application, but otherwise reserves all copyright rights whatsoever.

### FIELD OF THE DISCLOSURE

The present disclosure relates generally to online messaging systems and methods. More specifically, the present disclosure relates to means for creating, managing and using messaging systems enabling users to search and post messages on a map using spatio-temporal coordinates.

### BACKGROUND OF THE DISCLOSURE

Modern software-implemented applications, including mobile Apps, widely use geographic coordinates and time-related coordinates. Agenda-centric systems such as Google Calendar™, Any.do™ or Microsoft Outlook™ Calendar are used to plan future activities and to keep track of past activities. Map-centric applications such as Apple Maps™, Waze™ or Google Maps™, contextualize user's geographic position in order to helping users fulfilling their transportation-related activities including navigation, multi-modal mobility, point-of-interest and tourism related activities.

Few applications use a combination of temporal and spatial coordinates. One example relates to so-called “Time tools”, such as interactive historical maps (such as per example geographic information system (GIS) Flood Maps) where information is presented along a timeline over a geographical map, for general information, analytical and educational purposes. Another example relates to “lost-and-found” tools allowing users to post information with respect to goods found in specific location at specific time.

Yet, fewer applications use spacetime to enable connection between individuals. In an example, dating apps such as Tinder™ and Happn™ offer proximity-based search functionalities using path intersection coordinates to provide real-time information about the relative geographical proximity of potential matches, relative to user's location. In another example, messages billboard and to send personal message at specific times, as is the case with the SafeBeyond™ service allows users to map out their memories, regrets and yearnings and to send after-death messages. Other systems consider very specific use-cases, such as reuniting families separated by natural disasters.

Social networks enable person-to-person communication using built-in messaging functionalities in various ways, per example in the context of sport-related activities using the Strava™ and Swift™ applications, or with billboard of pictures and hobbies using the Pinterest™ and Instagram™ services. Social networks require that each user builds a virtual identity comprising minimally a sole username. Unless a user configures its service parameters as to allow be identified by its name, employer, affiliations, friends list, phone number, email address or other personal detail, these services identify users only by their virtual identities. It is therefore impossible to use such a messaging functionality to locate a particular person without knowledge of its virtual identity. Also, users have to disclose personal information's (i.e. personal profiles) to gain other users' trust to be able to engage with them, although users would prefer in many cases hiding some or all of their personal information.

Messaging applications not qualifying as social networks, as per example the WhatsApp™ service, enable search of a person and person-to-person communication using user's phone number or email address. In which case, proper identification of a user recipient requires pre-existing knowledge between the communicants and cannot be established on the sole knowledge of a user's virtual identity.

Each people exist in a specific spacetime subset, and the possibility that a social interaction between two persons spontaneously materializes in real life at a given place or time, or not, is function of innumerable variables. Social networks are developed with the primary objective of optimizing the amount of user's time spend online, without consideration for enabling, or not, serendipitous real-life interactions.

Current social network platforms make it almost impossible to connect individuals whose personal information are unknown to each other but who have met or shared an interaction at a specific time and place. Personals section of printed newspapers, with their online equivalent Craigslist's™ missed connections section, enable posting of ads or messages with the intention of reaching out to persons based on past interactions, but these messages are not posted within a geographical and temporal graphical representation, nor could they be easily searched, retrieved and distributed.

Consequently, no system of the prior art provides users with a way of connecting virtually using only information related to such users' real-life interaction, per example a past encounter at a specific place and time.

Consequently, no system of the prior art provides users with a simple, convenient way of identifying each other or to post messages to one other, based on respective attendance at a specific geographical location.

Consequently, no such system provides a means to easily program, configure and manage the delivery of various messages and media accessible to users, on the basis of relationship between such messages and media to specific geographical location and temporal coordinates.

### SUMMARY OF THE DISCLOSURE

It would thus be desirable to be provided with a system and a method that would at least partially solve one of the problems previously mentioned or that would be an alternative to the existing technologies.

In accordance with a broad aspect of the present technology, there is provided a system and method for messaging using spatio-temporal coordinates that enable users to connect virtually through the sole knowledge of their real-life interaction.

One or more embodiments of the present technology aim to provide a system and method for messaging using a graphical representation of geographical and temporal coordinates.

One or more embodiments of the present technology aim to provide a system and method for messaging using spatio-temporal coordinates that gives users the benefit of a messaging service, without having to build virtual identities to connect to unknown individuals.

One or more embodiments of the present technology aim to provide a system and method for messaging using spatio-temporal coordinates that is easy to program, to configure and to for the purpose of delivering messages and information to users, on the basis of relationship between such messages and information to specific geographical location and temporal coordinates.

In accordance with a broad aspect of the present technology, there is provided a computer-implemented method for posting messages on a graphical representation of a location. A non-limiting example of the computer-implemented method includes selecting a set of coordinates using a graphical representation of a geographical location, in which the set of coordinates include a geographical location, the area or dimension information, and a time or a time span. The method includes attaching a post to the set of coordinates, the post containing text and optionally hyperlinks, image files, audio files or video files. The method further includes searching and retrieving posts, which visibility can be filtered by navigating a graphical representation of a geographical location in longitude, latitude and scale and by selecting a time, a time frame, a time interval or a duration, using a time-sequencing graphical representation. Filtering is achieved by using a magnification tool for zoom-in over said graphical representation. Time selecting is achieved by moving a scale (a glider) to the representation of a specific time and optionally its duration, expressed as a span between a start date and an end date. The method further includes augmenting said posts by further contributions from any user, in the form of answers to a post, or contribution to a tread of messages. Users can participate by viewing, creating of replying to posts. Anonymous users can enter in relation with unlimited amount of other anonymous user through relational posts.

In accordance with a broad aspect of the present technology, there is provided a computer-implemented system for posting and retrieving messages on a graphical representation of a location. The system includes one or more processors operatively connected to one or more non-transitory storage mediums comprising instructions. The one or more processors, upon executing the instructions is configured to execute a method. A non-limiting example of the method includes selecting a set of coordinates using a graphical representation of a geographical location, in which the set of coordinates include a geographical location, the area or dimension information, and a time or a time span. The method includes attaching a post to the set of coordinates, the post containing text and optionally hyperlinks, image files, audio files or video files. The method further includes searching and retrieving posts, which visibility can be filtered by navigating a graphical representation of a geographical location in longitude, latitude and scale and by selecting a time, over a time-sequencing graphical representation. Filtering is achieved by using a magnification tool for zoom-in over said graphical representation. Time selecting is achieved by moving a scale (a glider) to the representation of a specific time and optionally its duration. The method further includes augmenting said posts by further contributions from any user, in the form of answers to a post, or contribution to a tread of messages. Users can participate by viewing, creating of replying to posts. Anonymous users can enter in relation with unlimited amount of other anonymous user through relational posts.

In accordance with a broad aspect of the present technology, there is provided a computer program product for posting and retrieving messages on a graphical representation of a location, the computer program product comprising a computer readable storage medium having program instructions embodied therewith. The program instructions are executable by a system comprising one or more processors to cause the system to perform a method. A non-limiting example of the method includes selecting a set of coordinates using a graphical representation of a geographical location, in which the set of coordinates include a geographical location, the area or dimension information, and a time or a time span. The method includes attaching a post to the set of coordinates, the post containing text and optionally hyperlinks, image files, audio files or video files. The method further includes searching and retrieving posts, which visibility can be filtered by navigating a graphical representation of a geographical location in longitude, latitude and scale and by selecting a time, over a time-sequencing graphical representation. Filtering is achieved by using a magnification tool for zoom-in over said graphical representation. Time selecting is achieved by moving a scale (a glider) to the representation of a specific time and optionally its duration. The method further includes augmenting said posts by further contributions from any user, in the form of answers to a post, or contribution to a tread of messages. Users can participate by viewing, creating of replying to posts. Anonymous users can enter in relation with unlimited amount of other anonymous user through relational posts.

Additional technical features and benefits are realized through the techniques of the present technology. One or more embodiments and aspects of the present technology are described in detail herein. For a better understanding, refer to the detailed description and to the drawings.

### BRIEF DESCRIPTION OF THE DRAWINGS

The following drawings represent examples that are presented in a non-limitative manner.

FIG. 1A shows a block diagram of a messaging environment using spatio-temporal messaging in accordance with one or more non-limiting embodiments of the present technology.

FIG. 1B shows a block diagram of a messaging system using spatio-temporal coordinates of FIG. 1A in accordance with one or more non-limiting embodiments of the present technology.

FIG. 2 shows a block diagram of the contexts of use of a messaging system using spatio-temporal coordinates of FIG. 1A in accordance with one or more non-limiting embodiments of the present technology.

FIG. 3A shows a message marker using spatio-temporal coordinates that may be used in the process illustrated in FIGS. 4 and 5 in accordance with one or more non-limiting embodiments of the present technology.

FIG. 3B shows a message displayed over a spatial map and time glider that may be used in the process illustrated in FIGS. 4, 5 and 6 in accordance with one or more non-limiting embodiments of the present technology.

FIG. 3C shows edition of new spatio-temporal message that may be used in the process illustrated in FIG. 4 in accordance with one or more non-limiting embodiments of the present technology.

FIG. 3D shows a new spatio-temporal message with selection of time coordinates that may be used in the process illustrated in FIGS. 4 and 5 in accordance with one or more non-limiting embodiments of the present technology.

FIG. 4 shows a flowchart of a process for creating a message using geo-temporal coordinates in accordance with one or more non-limiting embodiments of the present technology.

FIG. 5 shows a flowchart of a process for retrieving and editing a message using geo-temporal coordinates in accordance with one or more non-limiting embodiments of the present technology.

FIG. 6 shows a flowchart of an alternative process for editing a message using geo-temporal coordinates in accordance with one or more non-limiting embodiments of the present technology.

FIG. 7 shows a flowchart of a process for selecting time coordinates using a graphic representation of time in accordance with one or more non-limiting embodiments of the present technology.

FIG. 8 shows a flowchart of a process for signing-in to the spatio-temporal messaging system in accordance with one or more non-limiting embodiments of the present technology.

FIG. 9 shows a block diagram of an embodiment illustrating various possible user interactions using a spatio-temporal messaging system of FIGS. 1A, 1B and 2 in accordance with one or more non-limiting embodiments of the present technology.

### DETAILED DESCRIPTION OF THE DISCLOSURE

Various embodiments of the present technology will be described in detail with reference to the drawings, where like reference numerals represent like parts and assemblies throughout the several views. Reference to various embodiments does not limit the scope of the present technology, which is limited only by the scope of the claims attached hereto. Among other things, the present technology may be embodied as methods, systems or devices.

Additionally, any examples set forth in this specification are not intended to be limiting and merely set forth some of the many possible embodiments for the claimed invention. Moreover, the various tasks and process steps described herein can be incorporated into a more comprehensive procedure or process having additional steps or functionality not described in detail herein. Accordingly, the present technology may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. As used herein, the terms “comprises,” “comprising,” “includes,” “including,” “has,” “having,” “contains” or “containing,” or any other variation thereof, are intended to cover a non-exclusive inclusion. For example, a process, method or system that comprises a list of elements is not necessarily limited to only those elements but can include other elements not expressly listed or inherent to such, process, method or system.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Various connections and positional relationships (e.g., over, below, adjacent, etc.) are set forth between elements in the following description and in the drawings. These connections and/or positional relationships, unless specified otherwise, can be direct or indirect, and the present technology is not intended to be limiting in this respect. Accordingly, a coupling of entities can refer to either a direct or an indirect coupling, and a positional relationship between entities can be a direct or indirect positional relationship.

Additionally, variations in the arrangement and type of the components illustrated in the various figures of this disclosure may be made without departing from the spirit or scope of the technology.

Briefly stated, certain embodiments of the technology are related to a method and a system for messaging using spatio-temporal coordinates, enabling the objective of simplifying the connection of people through the sole knowledge of their real-life interactions. The method further includes editing and publishing a message with spatio-temporal coordinates. The method further includes selecting spatio-temporal coordinates from graphical representations of time and space. The method further includes retrieving a message by filtering graphical representations of time and space and by selecting a marker on a spatial map. The method further includes editing by a second user of a message posted by a first user. The system further includes private and public messaging functions.

Illustrative Operating Environment

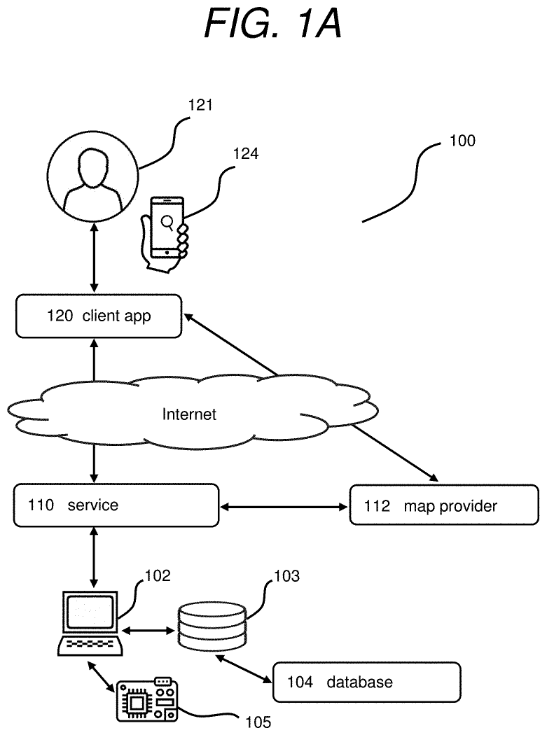

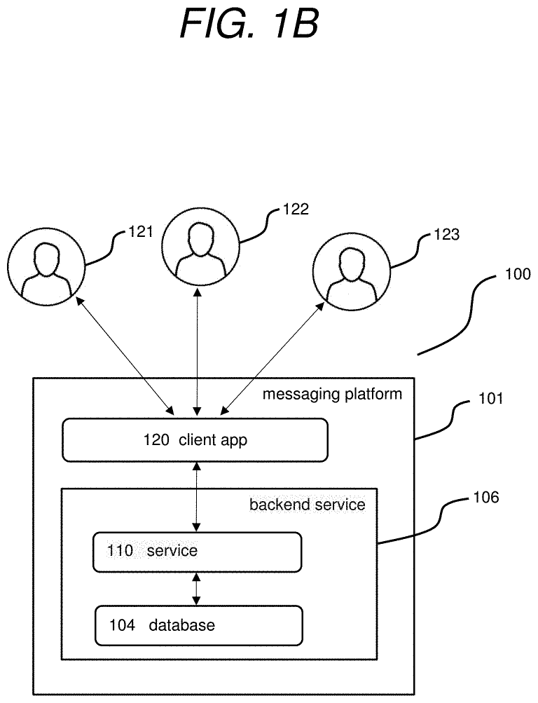

FIGS. 1A and 1B show components of a messaging environment in which one or more embodiments of the present technology may be implemented. As shown, a messaging environment 100 of FIG. 1A includes a hosting server 102 typically installed with computational means comprising processor 105, memory means 103, at least one input device and at least one output device, communications means, an operation system and software applications including database 104 and service 110. Service 110 is a software application connecting remotely to client app 120, a software application operating by user 121 on user device 124. Client app 120 is per example a mobile app.

In an embodiment, service 110 and client app 120 connects to a map provider 112, per example a cloud-based provider of geographic information (such as Google Maps™ or Esri™), for the purpose of accessing spatial maps, point-of-interest, general information and meta-data related to said spatial maps. Service account 111 is managed by the operator of service 110. Database 104 stores all messages and meta data related to messages, geographical locations, time and user interactions, and is constructed on a relational model.

In one embodiment of messaging environment 100 illustrated by FIG. 1B, a messaging platform 101 comprises client app 120 and backend service 106, comprising service 110 and database 104. Client app 120 is accessible by a plurality of users including 121, 122 and 123 from their respective user device 124. Client app 120 constitutes the front end of messaging platform 101.

For example, and without limitation, server 102 may be a programmable logic unit, a mainframe computer, a server, a personal computer, a cloud-based program or system. Mobile device 124 may be a personal computer, a smartphone, a smart watch or a tablet device or any combination of the foregoing. Processor 105 may be implemented in hardware or software, or a combination of both. It may be implemented on a programmable processing device, such as a microprocessor or microcontroller, a Central Processing Unit (CPU), a Digital Signal Processor (DSP), a Field Programmable Gate Array (FPGA), general purpose processor, and the like.

Processor 105 can be coupled to memory means 103, which stores instructions used to execute software programs, including service 110. Memory means 103 can include non-transitory storage media, both volatile and non-volatile, including but not limited to, random access memory (RAM), dynamic random access memory (DRAM), static random access memory (SRAM), read-only memory (ROM), programmable read-only memory (PROM), erasable programmable read-only memory (EPROM), electrically erasable programmable read-only memory (EEPROM), flash memory, magnetic media, or optical media. Communications means is typically a wireless radio communication modem such as a Wi-Fi modem, or means to connect to a local area network (LAN) or a wide area network (WAN) using the Ethernet protocol.

Each software application is preferably implemented in a high-level procedural or object-oriented programming and/or scripting language to communicate with a computer system. However, the software applications can be implemented in assembly or machine language, if desired. In any case, the language may be a compiled or interpreted language. Each such software application on server 102 is preferably stored on memory means 103 and readable by processor 105 for configuring and operating the server 102 when memory 103 is read by the processor 105 to perform the procedures described herein. Each such software application on user device 124 is preferably stored on memory means or on an external storage device, and readable by a processor for configuring and operating the user device 124 when its memory is read by said processor to perform the procedures described herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a reference to cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. At the heart of cloud computing is an infrastructure that includes a network of interconnected nodes.

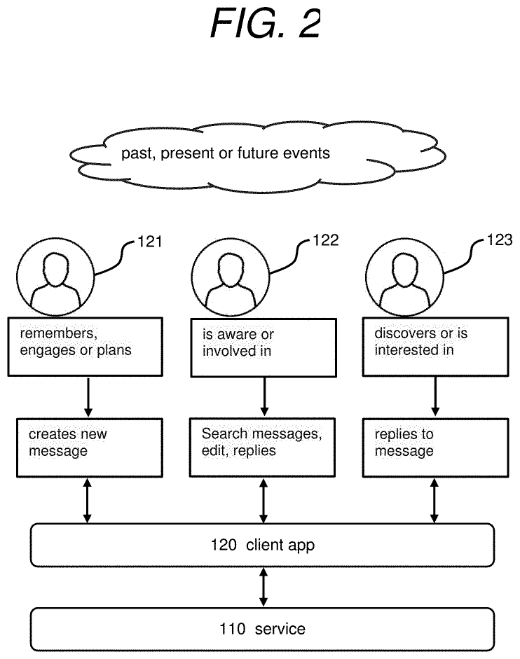

FIG. 2 illustrates user contexts in which the invention may be practiced. In one embodiment of the present invention, user 121, referred to as a “first user” either remembers a past event, engages in an event in the present time, or plans an event in the future time. An event can be any punctual or lasting action, object, and circumstances hereof. An action can be per example user 121 remembering having been “drinking a milkshake” on a given geographical location in presence of a group of persons. In a typical example, User 121 creates a new spatio-temporal message using client app 120, with the message title “drinking a milkshake” associated with geographical coordinates and time coordinates of where and when the event took place, and the milkshake was consumed. Said spatio-temporal message is stored on database 104 of messaging platform 101, and viewable to any user of client app 120.

User 122, referred to as the “second user”, was aware or involved of the event performed by first user 121 above; user 122 was part of the group of persons that shared or witnessed the milkshake consumption. User 122, after installing client app 120 on a mobile device 124 and registering to client app 120, browse spatio-temporal coordinates by navigating a graphical representation of a location, referred to as a spatial map, searching for spatio-temporal messages connected to geographical locations and time frames of interest to User 122. User 122 retrieves the “drinking a milkshake” message posted by first user 121, as user 122 remembers a past event associated to the geographical location and time frame connected to said message. User prompts the “drinking a milkshake” message and edit said message by adding a comment following the first comment by user 121, or my editing a reply to user 121. User 123, referred to as a “third user”, a milkshake aficionado, navigates a spatial map using spatial app 120, and search database 104 by a word-based search, for messages relevant to a key word, per example the key word “milkshake”. User 123 discovers the message titled “drinking a milkshake” posted by first user 121 and edited by user 122. User 123 further edit said message either by adding a comment following the first comment by user 122, or my editing a reply to user 121 and to user 122.

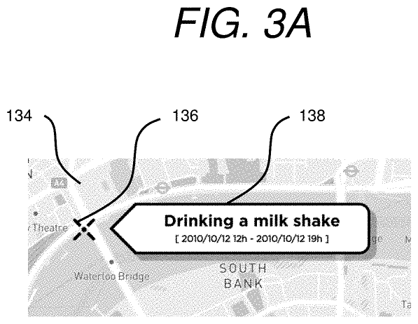

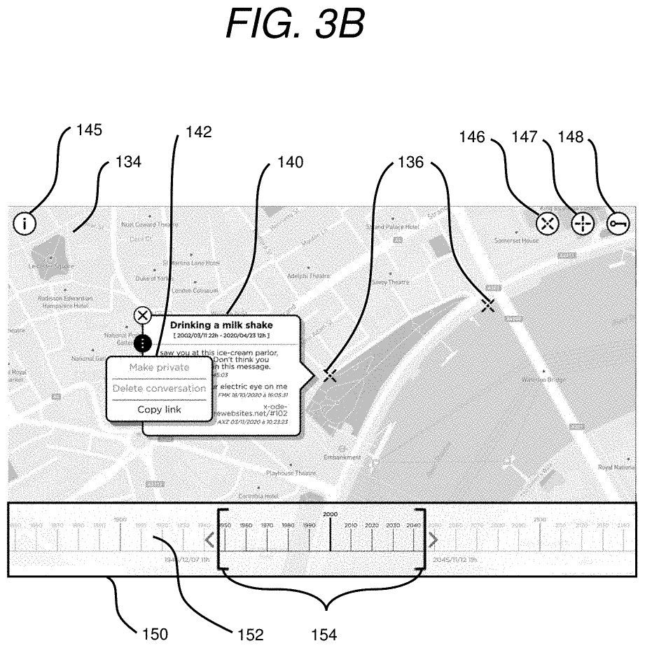

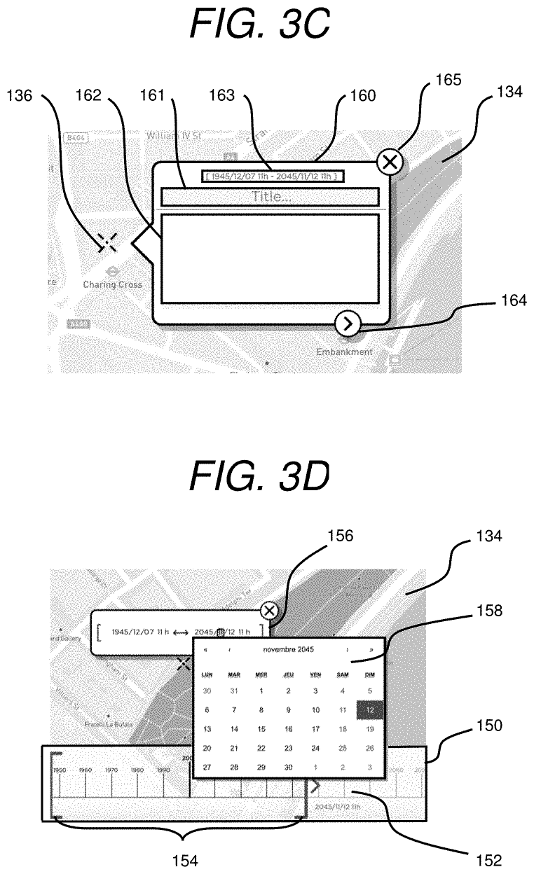

FIGS. 3A, 3B, 3C and 3D show components of an environment in which the present technology may be practiced. As shown, graphic interface excerpts displayed by client app 120, of FIGS. 3A, 3B, 3C and 3D include a map 134 representative of a geographical location or area, a marker 136 affixed on map 134 indicating the existence of a spatio-temporal message, and a descriptor 138 providing information about the spatio-temporal message marked by marker 136, as per example a message header and information referring to the time said message was posted or a reference duration relevant to said message. The geographical location illustrated by map 134 may be a city, a district, a building, an exhibition or any other interior or exterior arrangement of a building, outdoor location, or similar place of interest.

User 121 navigates map 134 in ways usual in the art, by scrolling horizontally to move the map horizontally and to affect longitude, by scrolling vertically to move the map vertically and to affect latitude, and by zooming in or out to affect map scale. Scrolling can be performed with different input device, including per example by touching and moving of finger or stylet on a touch-sensitive display, clicking and moving a mouse cursor, entry of numerical and other information values with a keypad, keyboard, or voice command, or with the identification of a point-of-interest represented by the spatial map, using keywords entered by keyboard, keypad, or voice command function of user device 124. Zooming can be performed by scrolling the wheel of a mouse or by using a magnifying tool on map 134, including per example clicking on icons representing the zoom function and the zoom off function.

Throughout this disclosure, “click” or “clicking”, “select” or “selecting” refers to a command, a selection or a data input on a graphical interface using any of the input method or device mentioned above.

In one embodiment of the invention, with reference to FIG. 3B, descriptor 138 is displayed on map 134 by moving a mouse cursor over marker 136 or by zooming-in on map 134 to increase the surface area covered by marker 136 on a location visible on map 134. Selecting descriptor 138 displays message 140 on map 134. Message 140 includes a message header, time coordinates, text and optionally an object within a list of objects comprising a hyperlink, image file, audio file or video file. A hyperlink is a link allowing any information over the Internet referred to by a specific URL to be accessible from an Internet browser or a mobile app, or other means. Additional functions available in editing box 142 in connection with message 140 include setting message publication privileged to “private” (restricted to private messaging between two or more users 121) or “public” (message 140 is available to all users 121), “delete” message function, and “copy link” providing a hyperlink to message 140 which can be included in any other message edited by a user 121. Functions of editing box 142 are typically restricted to the user 121 which first edited message 140, or to the system administrator.

Only a user that is a message creator can delete a message or set the privileges on a message to “private” mode. Only a second user that is not the message creator can reply to a message. Any user can reply to a message which publication privileged is set to “public”.

Client app 120 enables display of additional functions on map 134 including, per example, display of information using the information icon 145, display or hide all markers 136 using the show market icon 146, display the centre of map 134 using the centre icon 147, and lock the map 134 using lock icon 148. Information icon 141 enable display of information related to the map 134 or the geographical location shown by map 134. Lock icon 144 enables disabling of browsing function so that map 134 appears fixed, relative to the display of user device 124.

In one embodiment of the present invention, time glider 150 is displayed over, next to, besides map 134. Time glider 150 is a graphical representation of time in the form of a scale 152 with units representing calendar units which can use any unit from a group comprising minutes, hours, days, weeks, months, years, decades, and centuries, which user 121 can move along one axis by clicking for the purpose of selection time coordinates comprising a start time and an end time. The past time is represented over one side of the axis, and the future time is represented over the opposite side of the axis. The time glider 150 can be displayed on the horizontal axis or on the vertical axis on spatial time 134 or on any other interface not showing map 134. Time coordinates representative of a duration are showed on scale 152 by brackets 154 or any graphical marker identifying a start time and an end time or a time duration, or by any other suitable graphical illustration easily identifiable on scale 152. Time coordinates can refer to a time, a time frame, a time interval or a duration.

In one embodiment of the invention, with reference to FIG. 3C, upon user 120 selecting a geographical location, a new marker 136 indicative of the geographical coordinates selected and a new message box 160 are prompted on map 134. Message box 160 comprises a header section 161 for indicating the title of message box 160 and a text box 162 fillable and editable by user 120 with a text entry input device. Message box 160 further comprises a time coordinates box 163 for selection by user 120 using time glider 150, an enter button 164 enabling publication of a message, and an erase button 165 enabling deletion of message box 160.

In one embodiment of the invention, with reference to FIG. 3D, time box 156 and calendar box 158 are prompted when a user clicks on time coordinates box 163. Selection of time coordinates including a start time and an end time can be performed either by text entry on time box 156, alternatively by selecting dates and times from calendar 158, or alternatively by scrolling the time glider 150 and selecting by clicking on the desired location on the time scale 152. Selection of time coordinates using time box 156 or calendar 158 automatically positioned time scale 152 and brackets 154 to show selected start time and end time.

In one embodiment of the present invention, a message is displayed relative to the geographic location and zoom level displayed by map 134 visible on device 124 interface, and relative to the position of the scale 152 over time glider 150.

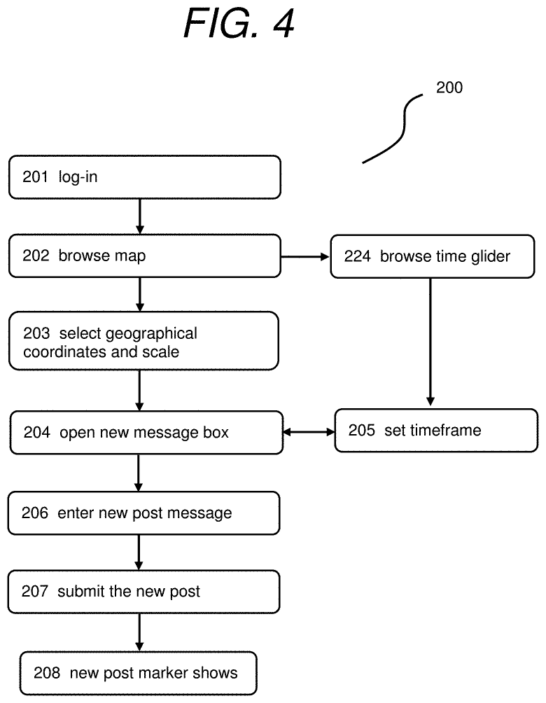

FIG. 4 shows steps of a computer-implemented method for posting messages using a graphical representation of a location in accordance with one or more non-limiting embodiments of the present technology. As shown, a method to post a message 200 of FIG. 4 comprises in succession: a first step “log-in” 201 where user 121 logs-in to client app 120; a second step “browse map” 202 where user 121 access a map 134 including time glider 150; a third step “select geographical coordinates and scale” 203 where user 121 navigates map 134 and selects a geographical location and the scale of the map using one of the way usual in the art discussed above; a fourth step “open new message box” 204 where selection of geographical location as per the geographical coordinates 203 step prompts a new message box 160 to open; a fifth step “set timeframe” 205 where user 121 selects time coordinates using either time box 156, calendar box 158 or time glider 150 as per the method discussed above; a sixth step “enter new post message” 206 where user 121 edits a new message containing text and optionally other information and content using message box 160; a seventh step “submit the new post” 207 where user 121 publishes a new message using the enter button 164; and an eight step “new post marker shows” 208 where messaging platform 101 creates a marker 136 connected to the geo-spatial coordinates selected by user 121 as per the steps above.

In one embodiment of the present invention and alternative method for posting messages 200 of FIG. 4 comprises in succession: first step 201; second step 202 where user browse map 134; third step “browse time glider” 224 where user 121 navigates time glider 150 displayed on map 134; a fourth step “set timeframe” 205 where user 121 selects time coordinates by clicking on scale 152 or by moving brackets 154 over scale 152; fifth step 204 where step 205 prompts a new message box 160 to open; sixth step 206; seventh 207 and eight step 208, similar to the method above.

In one embodiment of the present invention and alternative method for posting messages using a graphical representation of a location, users logs-in to client app 120, and accesses time-glider 150 without map 134. User 121 then selects timeframe, opens new message box, enter new post message, submit the new post following the steps described above.

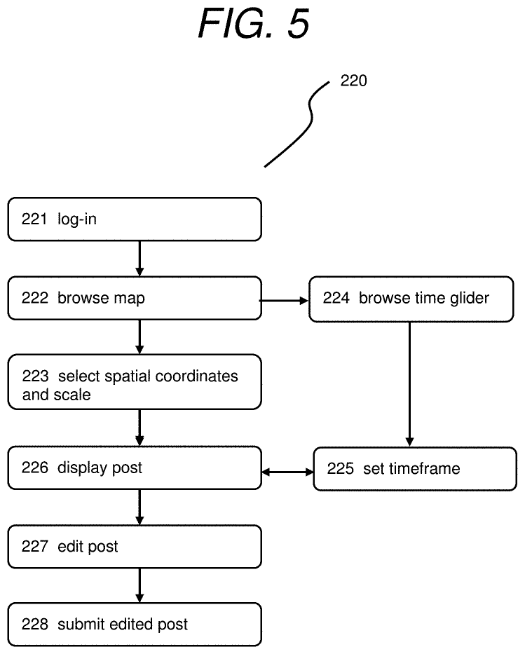

FIG. 5 shows steps of a computer-implemented method for retrieving and editing messages using a graphical representation of a location, in accordance with one or more non-limiting embodiments of the present technology. As shown, a method to retrieve and edit a message 220 of FIG. 5 comprises in succession: a first step “log-in” 221 where a first user 121, a second user 122 or a third user 123 (hereinafter referred to as a single person in this paragraph and the following paragraphs by the “user”) logs-in to user app 120; a second step “browse map” 222 where user access a map 134 and select map scale; a third step “select spatial coordinates and scales” 223 similar to step 203; a fourth step “display post” 226 where step 223 selection prompts a message 140 corresponding to the spatial coordinates selected by user; a fifth step “edit post” 227 where user replies to, privatizes, publishes or delete a message 140 in the ways discussed above; a sight step “submit edited post” 228 where user publishes the edited message using the enter button 164.

In one embodiment of the present invention and alternative method for retrieving and editing messages 220 of FIG. 5 comprises in succession: first step 221; second step 222 where user browse map 134; third step “browse time glider” 224 where user 121 navigates time glider 150 displayed on map 134; a fourth step “set timeframe” 225 where user 121 selects time coordinates by clicking on scale 152 or by moving brackets 154 over scale 152; fifth step 226 where step 225 prompts a message box 140 to open; sixth step edit post 227; seventh step submit edited post 228.

In an embodiment, therefore, a message is browsed and retrieved first by selecting geographic coordinates on a spatial map and second by selecting time coordinates using a graphical representation of time. In another embodiment of the present technology, a post is retrieved first by selecting time coordinates using a graphical representation of time, and second time by selecting geographic coordinates using a spatial map.

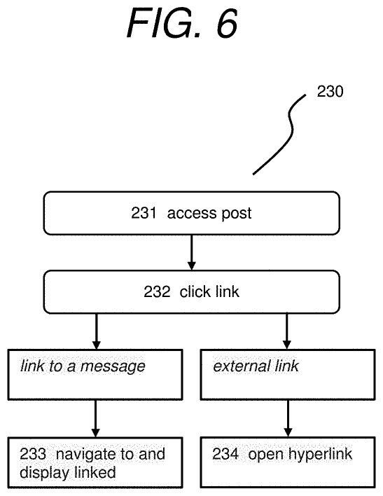

FIG. 6 shows steps of a computer-implemented method for editing messages using geo-temporal coordinates in accordance with one or more non-limiting embodiments of the present technology. As shown, a method to edit a message 230 of FIG. 6 shows a flowchart of an embodiment of an alternative process for editing a message, comprises in succession: a first step “access post” 231 where a message 140 is prompted by user performing display post step 226, wherein message 140 includes an hyperlink; a second step “click link” 232 where user activates the hyperlink by clicking on an hyperlinked text or object; a third step “navigate to and display linked message” 233 where another message 140 is prompted and displayed, when the hyperlink links to a message within messaging platform 101; a fourth step “open hyperlink” 234 which, when the hyperlink refers to an external link, an external link is opened in a new tab within client app 120, enabling an internet browser to open a web page identified with a URL.

In one embodiment of the present technology, a message is browsed and retrieved first by selecting geographic coordinates on a spatial map and second by selecting time coordinates using a graphical representation of linear time. In another embodiment of the present technology, a post is retrieved first by selecting time coordinates using a graphical representation of linear time, and second time by selecting geographic coordinates using a spatial map.

In one embodiment, messaging platform 101 enables person-to-person communication through the publication of a message 140 by a first user 121 and a reply to first user by a second user 122 which have a pre-established relationship with user 121, or by a third user 123 which do not have a pre-existing relationship with first user 121. Therefore, messaging platform 101 can be used to connect two person or more, in relation with an event identified by spatio-temporal coordinates, and a message header descriptive of a past event.

In one embodiment, unlimited number of users 121, 122 and 123 can edit any message 140, by public or private replies, or treads of messages 140 referring an original message 140 using hyperlink activate using copy link function. Users can participate by viewing, creating of replying to posts.

In one embodiment, the visual design of marker 136 can be configured, per example with a specific icon or an icon color referring to a community code, to designate different categories of message 140 related to said marker 136, including per example, with reference to a user 121 navigating map 134: messages personally posted by user 121 (marker 136 is then identified with a color, per example red color), message created by another user, to which user 121 had replied (marker 136 is then identified with another color, per example orange color), message created by other users that replied to messages created by user 121 (marker 136 is then identified with another color, per example white color), and messages which include an hyperlink opening a new tab (marker 136 is then identified with another color, per example blue color).

In another embodiment, user 121 can publish a message 140 without the expectation of receiving a reply from another user, but rather with the aim of documenting, recalling or interacting with a particular spacetime subset. Time glider 150 enables important jumps in time and enable documenting event spanning to a remote past.

In another embodiment, messaging platform 101 can be used as an efficient tool in critical situations, such as a natural disaster, riot, conflict or visit to crowded locations such as themed entertainment venues, concerts or mega-malls. Per example, whenever family members or team members lose sight of each other for a short or a long period of time, a member can use messaging platform 101 to publish messages tagged with geographical coordinates of locations well-known to other members, and tagged with time specification of a broad duration, therefore leaving a marker as a virtual return point for the members to communicate at any given moment.

In another embodiment, messaging platform 101 can be used to position a marker 136 with header and message 140 at precise location and time coordinates identifying where and when family members lost sight of each other for the last time, or were seen by other user 123 or 123. This function can be used by members above or by staff of relief organization (per example, UNHCR and ICRC). In another embodiment messaging platform 101 can be used to position markers 136 with header at locations where an object, a suspect criminal, a stray animal, or any moving subject, was seen by users in a given geographic areas, enabling determination of paths and assessment of future location of said subject.

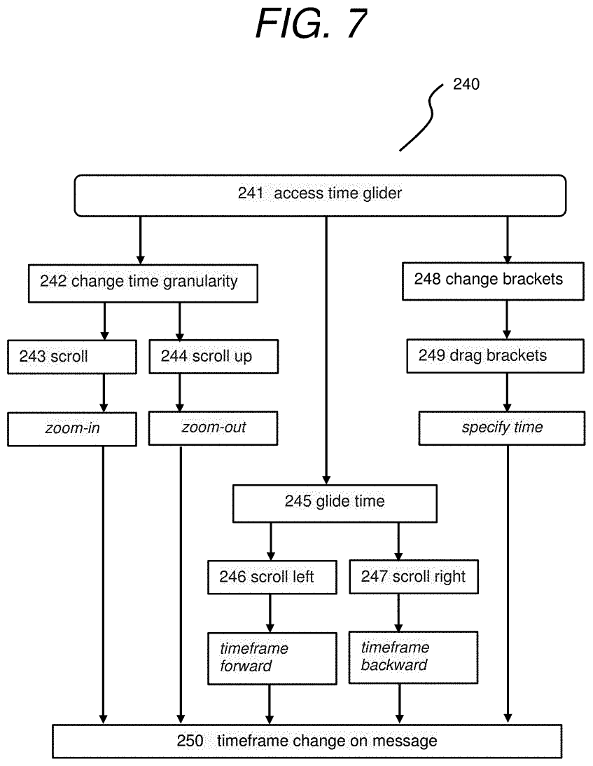

FIG. 7 shows steps of a computer-implemented method for selecting time coordinates using a graphic representation of time in accordance with one or more non-limiting embodiments of the present technology. As shown, a method for selecting time coordinates 240 of FIG. 7 shows a flowchart of an embodiment of methods of using time glider 150, comprises in succession: a first step “access time glider” 241 where user prompts a new message box 160 or a message 140 and time glider 150 is displayed over map 134 or in absence of any spatial map.

a step “change time granularity” 242 where user uses time glider 150 with a first method, by scrolling over an axis opposite the axis of time scale 152, using an input device, as per example the centre wheel of a mouse or by touching a touch-screen; a sub-step “scroll down” 243 where users scrolling in a first direction opposite axis of scale 152 causes zooming-in on time scale 152 and increases the granularity of the information displayed on scale 152, per example showing gradually weeks then days and hours; a sub-step “scroll up” 244 where user scrolling in a second direction opposite axis of scale 152 causes zooming-out on scale 152 and decreases the granularity of the information displayed on scale 152, per example showing gradually weeks, then months and years; wherein time coordinates representative of a duration comprising a start time and an end time are determined by the information of scale 152 displayed between brackets 154 after sub-steps 243 and 244 are performed;

a step “glide time” 245 where user uses time glider 150 with second method, by scrolling along the axis of scale 152, using an input device, as per example the pointer of a mouse or by touching a touch-screen; a sub-step “scroll left” 246 where user scrolling in a direction along scale 152 causes movement of timeframe backward in time; a sub-step “scroll right” 247 where users scrolling in the opposite direction along the axis of time scale 152 causes movement of timeframe forward in time; wherein time coordinates representative of a duration comprising a start time and an end time are then determined by the information of scale 152 displayed between brackets 154 after sub-steps 253 and 254 are performed;

a step “change brackets” 248 where user uses time glider 150 with a third method, by affecting the position of one or the two brackets 154 relative to the time information displayed on scale 152, wherein in a sub-step “drag brackets” 249, user drags a first and a second bracket 154 over the scale 152 by either clicking on the sale 152, or by clicking on each said brackets 154 and dragging them individually along a suitable position on scale 152, wherein time coordinates representative of a duration comprising a start time and an end time are then determined by the information of scale 152 displayed between brackets 154 after sub-step 263 is performed;

In an embodiment, step “timeframe change on message” 250, determination of time coordinates by any sub-step of step 242, 252 or 262 changes the time coordinates associated with a new message 160.

In an embodiment of the present technology, selecting time coordinates using a graphic representation of time can be performed by the successive use of step 242, step 252, or step 262, in any order, including the possibility of several iterations of each of steps 242, 252 and 262.

In an embodiment of the present technology, User 122 can specify time coordinates relevant to a reply to a first message 140, using any of the steps 242, 252 or 262, wherein said coordinates are published with said reply as a hyperlink which, when clicked by a user, moves the scale 152 in order to show said new time coordinates between brackets 154.

In an embodiment, a message 140 can be exported to a second platform, per example a social media platform. Wen user 121 post a message on a second platform including a hyperlink pointing to the URL specific to each message 140, any user of said second platform can view message 140, either from a tab opened within the second platform, or from a web page displayed by an Internet browser outside the second platform.

In an embodiment of the present technology, users can anonymously access the messaging platform 101 and freely roam through it by reading descriptors 138, and by replying to existing messages 140 or by creating new messages 160. The messaging platform 101 randomly attributes a unique username to new users who will automatically retain it for future sessions if they use the same hardware and software environment. To secure their unique username for use on different hardware and software environments, users can sign up by providing an email address and password combination through which they will be able to sign in for future sessions.

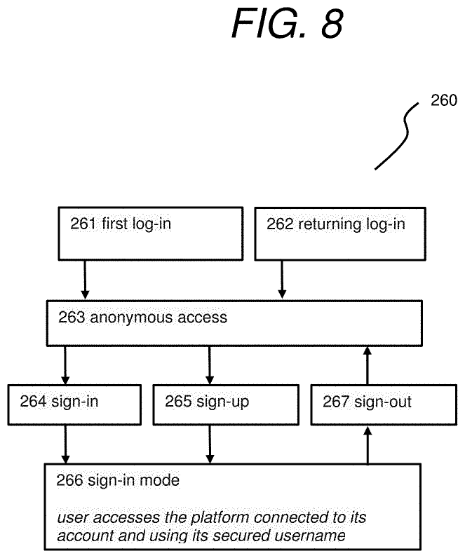

FIG. 8 shows steps of a computer-implemented method for managing usernames in accordance with one or more non-limiting embodiments of the present technology. As shown, a method for managing usernames 260 of FIG. 8 shows a flowchart of an embodiment of login processes, comprises in succession: a step “first log-in” 261 where a user is attributed a randomly selected username on user's first log-in to the platform, and step “returning log-in” 262 where same user logs-in through a new session and is attributed the same username as in step 261; a step “anonymous access” 263 where user use messaging platform 101 unanimously using its system attributed username; step “sign-in” 264 where user enters sign-in information including either a user name, an account name, an email address or a phone number, and a password or any other identification mean, to sign-in to messaging platform 101; step “sign-up” 265 where user registered to messaging platform and confirms a username, a password and any identification information for sign-in to the platform; step ‘“sign-in mode”’ 266 where user uses the messaging platform 101 using the username determined by user; step “sign-out” 267 where, upon the user signing out of the platform, user can continue to use the platform anonymously using a username determined randomly by the system.

In an embodiment of the present technology, messaging platform 101 attributes a username to a user based upon the specific environment from which said user access messaging platform 101. Per example, user 121 registering to client app 120 will be attributed a username by default. Whenever client 121 access messaging platform 101 by using client app 120 (in this context, an “environment”), client 121 will be identified within the system using the system determined username. To secure their unique username for use on different environments, a user can sign-up by providing an email address and password combination through which they will be able to sign in for future sessions. User 121 can change the username at any time using the profile configuration functions of client app 120. When, per another example, user 121 accesses the messaging system from a web page after clicking on a hyperlink without logging-in to client app 120, the messaging platform 101 will attribute a new username to client 121.

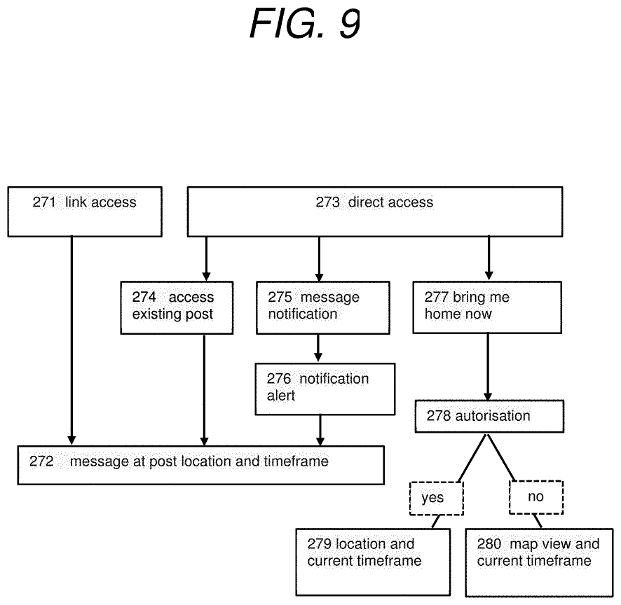

FIG. 9 shows a block diagram of an embodiment illustrating various possible user interactions using a spatio-temporal messaging system of FIGS. 1A, 1B and 2. A user 121 can access platform 101 by link access 271, from a hyperlink activated from another platform and opening a web page which user access a message at post location and timeframe 272, that is at the geographic coordinates and time coordinates attributed to said message. A 121 user can alternatively access platform 101 by direct access 273 by log-in, sign-in or sign-up using the method disclose above. A 121 user that signs-in to the system can receive a message notification 275 in various situations, per example when a user 122 or 123 replies to a message created by user 121, or when a message is created and referring to spatio-temporal coordinates about which user 121 has specified an alert. A notification alert 276 addressed to user 121, including a hyperlink enabling access directly to the message at post location and timeframe 272, is then sent to a mailbox within messaging platform 101. When activating function “bring me home now” 277, by confirming authorisation 278, platform 101 will set the map 134 and time glider 150 visible to user will be set to user's location and current timeframe 279. When user does not activate authorisation 278, platform 101 sets the map 134 and time glider 150 visible to user on a general world map view and timeframe view.

The person skilled in the art would understand that the various properties or features presented in a given embodiment can be added and/or used, when applicable, to any other embodiment covered by the general scope of the present disclosure.

The present disclosure has been described with regard to specific examples. The description was intended to help the understanding of the disclosure, rather than to limit its scope. It will be apparent to one skilled in the art that various modifications can be made to the disclosure without departing from the scope of the disclosure as described herein, and such modifications are intended to be covered by the present document.

What is claimed is:

1. A computer-implemented method for posting and retrieving messages using a graphical representation of a location, the method comprising:
selecting a set of spatio-temporal coordinates, including geographical coordinates selected from a spatial map, and time coordinates selected from a graphical representation of time;
editing a virtual post containing text;
associating the virtual post to the selected set of spatio-temporal coordinates;
publishing the post using a marker; and
retrieving the post by selecting a marker from a spatial map and a graphical representation of time;
wherein the geographical coordinates are filtered in longitude, latitude and scale parameters, and
wherein the time coordinates are filtered by moving a scale along a graphical representation of linear time.

2. The method of claim 1, wherein the geographical coordinates are representative of a geographical area.

3. The method of claim 1, further comprising filtering the geographical coordinates using a magnification tool over said spatial map.

4. The method of claim 1, further comprising selecting the time coordinates using a scale based graphical representation of linear time that is a scale movable along an axis, wherein the past time is represented over one side of the axis, and the future time is represented over the opposite side of the axis.

5. The method of claim 1, wherein the time coordinates comprise a start time and an end time.

6. The method of claim 1, wherein the time coordinates comprise a timespan.

7. The method of claim 1, further comprising publishing the post by at least one of: inserting a marker on a spatial map, and inserting a marker on a graphical representation of time.

8. The method of claim 1, further comprising retrieving the post first by selecting geographic coordinates on a spatial map and second by selecting a time using a graphical representation of linear time.

9. The method of claim 1, further comprising retrieving the post first by selecting a time using a graphical representation of linear time, and second time by selecting geographic coordinates using a spatial map.

10. The method of claim 1, wherein the post includes an object within a list of objects comprising hyperlinks, image files, audio files or video files.

11. The method of claim 1, further comprising publishing the post by a user for the purpose of communicating with a person.

12. The method of claim 1, further comprising editing, by the user, the post.

13. The method of claim 12, further comprising editing the post by way of an answer to the original post.

14. The method of claim 13, further comprising editing the post by way of communication tread starting with the original post.

15. A system for posting and retrieving messages using a graphical representation of a location, the system comprising:
a memory comprising instructions;
one or more processors operatively connected to the memory, with the one or more processors, upon executing the instructions, being configured for:
providing a spatial map;
providing a scale based graphical representation of time containing a scale movable along an axis, wherein the past time is represented over one side of the axis, and the future time is represented over the opposite side of the axis;
communicating with a computing device associated with a first user; and
receiving from first user a selection of spatio-temporal coordinates associated with a virtual post containing text, wherein the spatio-temporal coordinates include geographical coordinates selected from the spatial map, and time coordinates selected from the graphical representation of time;
publishing the post using a marker;
communicating with a computing device associated with a second user;
receiving from the second user input information about geographical coordinates on the special map filtered in longitude, latitude and scale parameters, and time coordinates filtered by moving a scale along the graphical representation of time;
receiving from the second user a selection identifying the marker;
receiving from the second user a post associated with said marker; and
publishing said post from second user.

16. The system of claim 15, wherein the post from the first user is published by performing at least one of: inserting a marker on a spatial map, and inserting a marker on a graphical representation of time.

17. The system of claim 15, wherein a post is retrieved one of:
first by selecting geographic coordinates on a spatial map and second by selecting a time using a graphical representation of linear time, and
first by selecting a time using a graphical representation of linear time, and second time by selecting geographic coordinates using a spatial map.

18. The system of claim 15, wherein the post includes an object within a list of objects comprising hyperlinks, image files, audio files or video files.

19. The system of claim 15, wherein the post is published by the first user for the purpose of communicating with a person.

20. The system of claim 16, wherein the post published by the second user is an answer to the post published by the first user.
